(19) United States
(12) Patent Application Publication
(10) Pub. No.: US 2023/0076621 A1
(43) Pub. Date: Mar. 9, 2023

(54) SYSTEM AND METHOD FOR STOPPED VEHICLE DRIVER ALERT

(71) Applicants: Mohammad S Huq, HAMTRAMCK, MI (US); Shakura Quabili, HAMTRAMCK, MI (US)

(72) Inventor: Mohammad Shafikul Huq, HAMTRAMCK, MI (US)

(73) Assignees: Mohammad S. Huq, HAMTRAMCK, MI (US); Shakura Quabili, HAMTRAMCK, MI (US)

(21) Appl. No.: 17/880,649

(22) Filed: Aug. 4, 2022

Related U.S. Application Data
(60) Provisional application No. 63/241,063, filed on Sep. 6, 2021.

(51) Int. Cl. B60W 30/18; B60W 50/16

(52) U.S. Cl. CPC B60W 30/18154; B60W 50/16; B60W 2520/04; B60W 2554/4045; B60W 2555/60; B60W 2554/4042; B60W 2554/802; B60W 2050/143

(57) ABSTRACT

The present invention is a system and method for stopped vehicle driver alert. The system gives alert to the driver at traffic light when a vehicle is stopped at red light, when the light changes from red to green, and/or when the front vehicle clears out moving away above a threshold distance. In preferred embodiments, system comprises optical sensors to detect traffic lights and changes of traffic light status, object detection and object distance measurement sensors, GPS location sensors, a microprocessor with memory, engine control module, and alert systems capable of playing or displaying alerts of audible, visual, and haptic formats. The system is also capable of generating engine start signal. The method detects if the ego vehicle is stopped due to a traffic light and/or traffic jam or a scenario where the front vehicle is almost stopped or within a threshold distance from the ego vehicle. When the condition changes. If the traffic light is red the method determines how long the red light will exist before changing to green with the help of precalculated table where red light duration of a particular GPS location on a particular road is given. The method also calculates a complete red light duration of it can detect the start of the red light and update the red light duration. The method generates remaining light duration signal and send the signal to audible or visual alert systems. Right before or after the remaining time turns to zero, the method generates audible, visual, and/or haptic signals and sends the signals to the audible, visual, and haptic alert systems and/or sends engine start signal to engine control module. The method also determines if red light changed to green and sends audible, visual, and/or haptic signals and/or engine start signal to engine control module.

### CROSS REFERENCE TO RELATED APPLICATION

This application is a continuation application of U.S. Provisional Patent Application No. 63/241,063, filed Sep. 6, 2021 with conformation number 2063, the contents of which are incorporated herein by reference almost in their entirety, with claims unchanged.

### FIELD OF THE INVENTION

The present invention relates to Advanced Driver Assist Systems (ADAS) or Automated Driving (AD) features. More particularly, the invention is a novel feature for alerting a driver (manual or automated driver) of a stopped vehicle; the feature is capable of giving a driver alert when the vehicle is stopped, i.e., its speed is zero or nearly zero at a traffic light and/or in a traffic jam. We give alert to the driver of a stopped vehicle when a vehicle stops at a red traffic light, and then a red traffic light changes from red to green, and/or the front objects start moving outside a threshold distancesp

### BACKGROUND

When drivers stop at a red traffic light, they remain uninformed about the duration of a red light. In the case of manual driving, this creates uncertainty that makes the drivers impatient adding to lack of comfort in driving. In the case of automated driving, the automated driver also remains uninformed.

In addition, human drivers easily get distracted with cell phones, roadside views, conversation with accompanying passengers, etc., when the ego vehicles stop at traffic lights or because there are stopped vehicles in front of the ego vehicle during a traffic jam or similar situation. When condition changes, i.e., the traffic light changes from red to green or the front vehicles clear out, a human driver is slow to response because of the distraction. This creates two problems: first, the slow response adds to travel delay to the other vehicles behind the ego vehicle and second, a possibility of friction arises between human drivers of the ego vehicle and the vehicles behind the ego vehicle.

Therefore, a need exists to give alert to a driver of a vehicle stopped at a traffic light and/or in a traffic jam or similar situation with stopped vehicle in front. An alert system can tell a driver duration of a red light to aid in informed driving. This adds to convenience in automated driving and comfort in human driving. The alert system can further avoid delay in response of the human driver when a red traffic light changes to green or the front vehicles clear out.

There are numerous patents related to detection traffic lights. U.S. Pat. No. 11,155,249 B2, for instance, estimates amount of time until the vehicle will reach the intersection. U.S. Pat. No. 11,080,539B2 recognizes the state of traffic lights at the target moment, according to the location information of the traffic lights at the target moment. U.S. Pat. No. 10,012,997B2 determines the status and details of a traffic light. The system and method of the proposed invention in sour application is entirely different—giving alert to a driver of an ego vehicle and/or giving engine start command to the ego vehicle that stopped at a traffic light and was waiting for the light to be green and/or for the front vehicle to cleared.

### BRIEF SUMMARY OF THE INVENTION

The present invention is a system and method for stopped vehicle driver alert. The system gives alert to the driver at traffic light when a vehicle is stopped at red traffic light, when the light changes from red to green, and/or when front vehicle clears out moving away outside a threshold distance. In preferred embodiments, the system comprises optical sensors to detect traffic lights and changes of traffic light status, object detection and object distance measurement sensors, GPS location sensors, a microprocessor with memory, engine control module, and alert systems capable of playing or displaying alerts of audible, visual, and haptic formats. The system is also capable of generating engine start signal.

The method detects if the ego vehicle is stopped due to a traffic light and/or traffic jam or a scenario where the front vehicle is almost stopped within a threshold distance from the ego vehicle. If the traffic light is red the method finds out how long the red light will remain red before changing to green with the help of precalculated table where red light duration of a traffic light close to a particular GPS location on a particular road is given. The method also calculates a complete red light duration if it can detect the start of the red light and update the red light duration table saved in the memory. The method generates remaining light duration signal and send the signal to audible or visual alert systems. Right before or after the remaining time turns to zero, the method generates audible, visual, and/or haptic signals and sends the signals to the audible, visual, and haptic alert systems and/or sends engine start signal to engine control module. The method also determines if red light changes to green and/or the front stopped vehicles clear out moving away outside a threshold distance and sends audible, visual, and/or haptic signals to audible, visual, and/or haptic alert systems and/or engine start signal to engine control module.

### BRIEF DESCRIPTION OF THE DRAWINGS

System and method of the present invention are illustrated as an example and are not limited by the figures of the accompanying diagrams and flowcharts, in which:

FIG. 1-FIG. 1 depicts a system comprising various sensors, information sources, processing units, engine control module, and alert systems.

FIG. 2-FIG. 2 depicts a flowchart that describes how different steps and routines are applied one after another sometimes in sequence and/or in loop at times to generate audible, visual. Haptic, and engine start signals.

### DETAILED DESCRIPTION OF THE INVENTION

The terminology used herein for the purpose of describing the system and method is not intended to be limiting the invention. The term ‘and/or” includes any and all combinations of one or more of the associated listed items. As used herein, the singular forms “a,” “an”, and “the” are intended to include the plural forms as well as singular forms, unless the context clearly indicates otherwise. The term “comprising” and/or “comprises” specify the presence, when used in this specification, specify the presence of stated features, steps operations, elements, and/r components, but do not preclude the presence or addition of one or more other features, steps, operations, elements, components, and/or groups/thereof.

If not otherwise defined, all terms used herein have the same meaning as commonly understood by one having ordinary skill in the art to which this invention belongs. Furthermore, terms, such as those defined in commonly used dictionaries, should be interpreted as having a meaning that is consistent with their meaning in the context of the relevant art and the present invention and will not be interpreted in an idealized or overly formal sense unless expressly so defined herein.

In the description of the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. However, the specification and claims should be read with the understanding that such combinations are entirely within the scope of the invention and the claims.

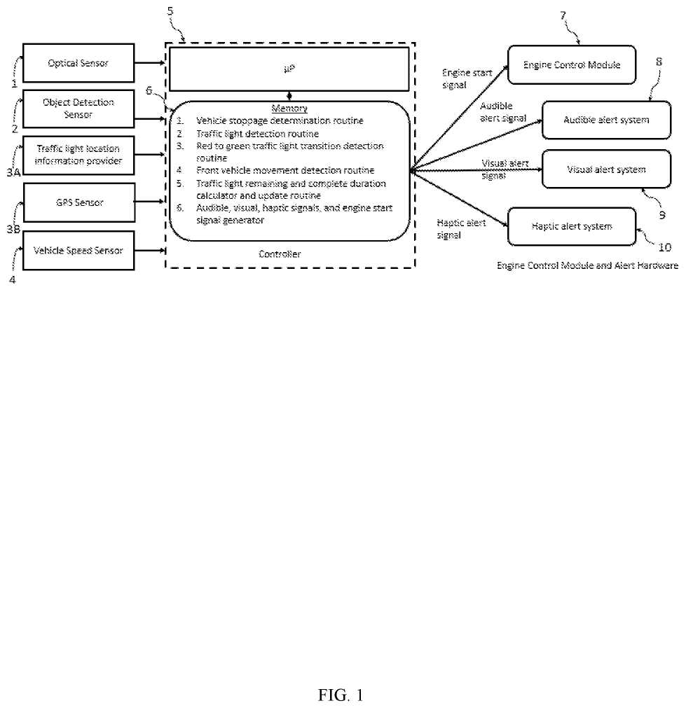

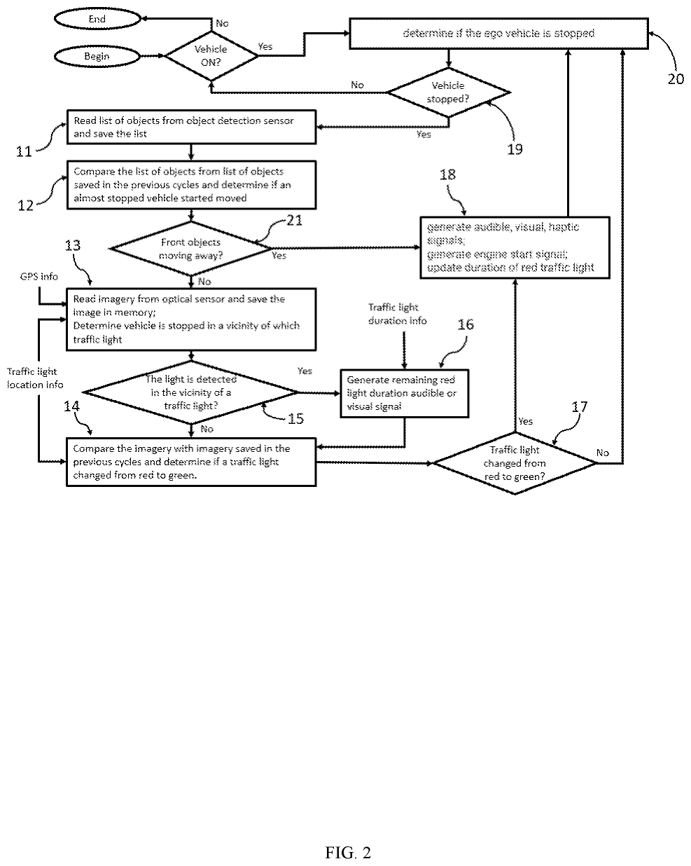

The present invention, a system and method for stopped vehicle driver alert, will now be described by referencing the appended figures, FIG. 1 and FIG. 2, representing the preferred embodiments. The system gives alert to the driver at traffic light when a vehicle is stopped at red traffic light, when the light changes from red to green, and/or when the front vehicle clears out moving away outside a threshold distance. In preferred embodiments, the system comprises optical sensors 1 to detect traffic lights and color changes of traffic lights, object detection sensor 2 that detects objects and measure distances of the objects, GPS sensor 3B, a microprocessor with memory 5, 6, engine control module 7, and alert systems capable of playing or displaying alerts of audible, visual, and haptic formats 8, 9, 10, vehicle speed sensor 4, and traffic light location information provider 3A. The system is also capable of generating engine start signal to engine control module 7.

The method detects if the ego vehicle is stopped 20, 19 due to a traffic light 13, 15 and/or traffic jam or a scenario where the front vehicle is almost stopped within a threshold distance from the ego vehicle 11, 12. If the traffic light is red 13, 15, the method determines how long the red light will remain red before changing to green with the help of precalculated table where red light duration of a traffic light close to a particular GPS location on a particular road is given. The method also calculates a complete red light duration if it can detect the start of the red light and update the red light duration table saved in memory 18. The method generates remaining light duration signal and send the signal to audible or visual alert systems 16. Before or after the remaining time turns to zero, the method generates audible, visual, and/or haptic signal and sends the signals to the audible, visual, and haptic alert systems and/or sends engine start signal to engine control module 16. The method also determines if red light changes to green 14, 17 and/or the front stopped vehicles clear out moving away outside a threshold distance 21 and sends audible, visual, and/or haptic signals to audible, visual, and/or haptic alert systems and/or engine start signal 18 to engine control module.

1. A system for use on a vehicle to give the driver of an ego vehicle, which is stopped, an alert and/or initiate engine start when traffic light changes from red to greed or when the front vehicle starts moving from an almost stopped status, said system comprising:
an optical sensor mounted on the vehicle for capturing imagery of the traffic light;
a motion sensor to determine if the ego vehicle is stopped;
traffic light location information provider;
a controller for analyzing imagery of the said optical sensor;
an object detection sensor which could be the said optical sensor itself or a different object detection sensor;
an engine control module that can receive the engine start signal and start the engine; and
audible, visual, or haptic alert systems that could be mobile and/or mounted on the vehicle.

2. The system as defined in claim 1, wherein the said controller determines if the vehicle is stopped.

3. The system as defined in claim 1, wherein the said traffic light location information provider could be a map service provider providing the location information dynamically as the vehicle travels or could be a list of predetermined traffic light locations;

4. The system as defined in claim 1, wherein the said controller further determines from the said imagery in claim 1 if traffic light is changed from red to green.

5. The system as defined in claim 1, wherein the said controller further generates audible, visual, haptic alert signals, and engine start signals.

6. The said visual alert signal as defined in claim 1 could be either optical or textual in nature delivered to a visual alert system.

7. The said visual alert system as defined in claim 1 could be a visual alert system installed on the ego vehicle or on a mobile device.

8. The said audible alert signal as defined in claim 1 could be a distinct sound or in the form of an instruction that changes volume of sound in a speaker or simply turn on a speaker.

9. A method to give the driver of a vehicle, that is stopped, an alert when traffic light changes from red to green or deliver to the engine control module an engine start signal when a stopped front object starts moving, said method comprising the steps:
determining if the ego vehicle is stopped;
determine if the vehicle is within a range of a traffic light and/or a traffic light is red;
determining if there is a slow or stopped object within a threshold distance and in the path of the ego vehicle;
determining if a traffic light changed from red to green if the ego vehicle was stopped due to a traffic light;
determining if a front object moved further outside a threshold distance if the ego vehicle was stopped due to the object being in front; and
generating audible, visual, haptic, and/or engine start signals if the traffic light changed from red to green and/or an almost stopped front object moved further outside a threshold distance.

10. A method that produces visual or audible signals expressing what the duration of a traffic light is as the vehicle stops at a red traffic light and giving the driver signals before the red light changes to green, the said method comprising, determining if a vehicle has stopped at a traffic light;
retrieving information from controller memory on how long the traffic light will stay red if the information is available;
determining the remaining duration of a red traffic light and sending audio and/or visual signals;
updating total duration of the traffic light in memory of the controller; and
generating visual or audible signals before and/or after the traffic light changes from red to green.

11. The method as defined in claim 10, wherein the said update in memory is made against geographic locations of the said traffic lights and the road the lights are on.
